(19) United States
(12) Patent Application Publication
(10) Pub. No.: US 2011/0098028 A1
(43) Pub. Date: Apr. 28, 2011

(54) METHOD AND SYSTEM FOR UPDATING A MOBILE DIALING NUMBER OF A TELEMATICS-EQUIPPED MOBILE VEHICLE

(75) Inventors: George A. Economos, Sterling Heights, MI (US); Gregory T. Brink, Grosse Pointe Farms, MI (US)

(73) Assignee: GENERAL MOTORS COMPANY, Detroit, MI (US)

(21) Appl. No.: 12/604,076

(22) Filed: Oct. 22, 2009

(51) Int. Cl. H04M 3/00

(52) U.S. Cl. 455/418

(57) ABSTRACT

A method and system for updating a mobile dialing number of a telematics-equipped mobile vehicle is disclosed herein. The method involves generating, via a processor operatively associated with an automated system at a call center, a mobile dialing number update trigger in response to an event. The call center is in selective and operative communication with an activated telematics unit having a first mobile dialing number. The method further includes recognizing the mobile dialing number update trigger via the automated system; and in response to the recognizing initiating a mobile dialing number update routine via the automated system. The automated system then selectively automatically updates the first mobile dialing number with a second mobile dialing number in response to the mobile dialing number update routine.

### TECHNICAL FIELD

The present disclosure relates generally to methods and systems for updating a mobile dialing number of a telematics-equipped mobile vehicle.

### BACKGROUND

Activated telematics units are often associated with a mobile dialing number, which enables the telematics unit to place and receive calls from, e.g., a call center or another party. The mobile dialing number often includes an area code that is local to a garage address of the mobile vehicle at the time the telematics unit is activated.

### SUMMARY

A method of updating a mobile dialing number involves generating a mobile dialing number update trigger in response to an event and recognizing the mobile dialing number update trigger via an automated system at a call center. The call center is in selective and operative communication with an activated telematics unit having a first mobile dialing number. The method further involves initiating, in response to the recognizing of the trigger, a mobile dialing number update routine and selectively automatically updating the first mobile dialing number with a second mobile dialing number in response to the mobile dialing number update routine.

Also disclosed herein is a system for accomplishing the same.

### BRIEF DESCRIPTION OF THE DRAWINGS

Features and advantages of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a schematic diagram depicting an example of a system for updating a mobile dialing number of a telematics-equipped mobile vehicle; and

FIGS. 2 through 5 are flow diagrams depicting various examples of a method for updating a mobile dialing number of a telematics-equipped mobile vehicle.

### DETAILED DESCRIPTION

Example(s) of the method and system disclosed herein may advantageously be used to update the mobile dialing number of a telematics unit of a mobile vehicle with a new, local dialing number. The updating may be accomplished in instances where i) the vehicle changes ownership, and/or ii) the vehicle owner changes his/her garage address. The updating is generally accomplished by recognizing an update trigger at a call center and, in some embodiments, automatically updating the telematics unit with a new dialing number in response to the recognized trigger. In other embodiments, once the trigger has been recognized by the call center, the vehicle owner may be prompted for authorization to proceed with an automatic update. In any event, the updating of the mobile dialing number advantageously i) provides a mobile dialing number that is local to the vehicle owner's current garage address, ii) reduces undesirable phone charges directed to the vehicle owner from using a mobile dialing number having an area code outside of the mobile dialing area, iii) reduces the number of subscriber-initiated calls to the call center requesting a mobile dialing number update, and/or iv) improves connectivity with the telematics unit at least by the call center. In instances where the vehicle changes ownership, examples of the method and system disclosed herein also advantageously reduce or even eliminate unwanted phone calls directed to the previous vehicle owner.

It is to be understood that, as used herein, the term “user” includes vehicle owners, operators, and/or passengers. It is to be further understood that the term “user” may be used interchangeably with subscriber/service subscriber. Furthermore, a “buyer” includes a person or other entity that is i) looking to purchase another vehicle, or ii) has already purchased the vehicle. It is to be understood that the term “buyer” may be used interchangeably with “customer”.

The terms “connect/connected/connection” and/or the like are broadly defined herein to encompass a variety of divergent connected arrangements and assembly techniques. These arrangements and techniques include, but are not limited to (1) the direct communication between one component and another component with no intervening components therebetween; and (2) the communication of one component and another component with one or more components therebetween, provided that the one component being “connected to” the other component is somehow in operative communication with the other component (notwithstanding the presence of one or more additional components therebetween).

It is to be further understood that “communication” is to be construed to include all forms of communication, including direct and indirect communication. As such, indirect communication may include communication between two components with additional component(s) located therebetween.

As further used herein, an “activated device” or an “activated telematics unit” is a device or telematics unit that has stored therein a mobile dialing number. Such mobile dialing number, when stored in the device, enables the device or the telematics unit to place and receive calls.

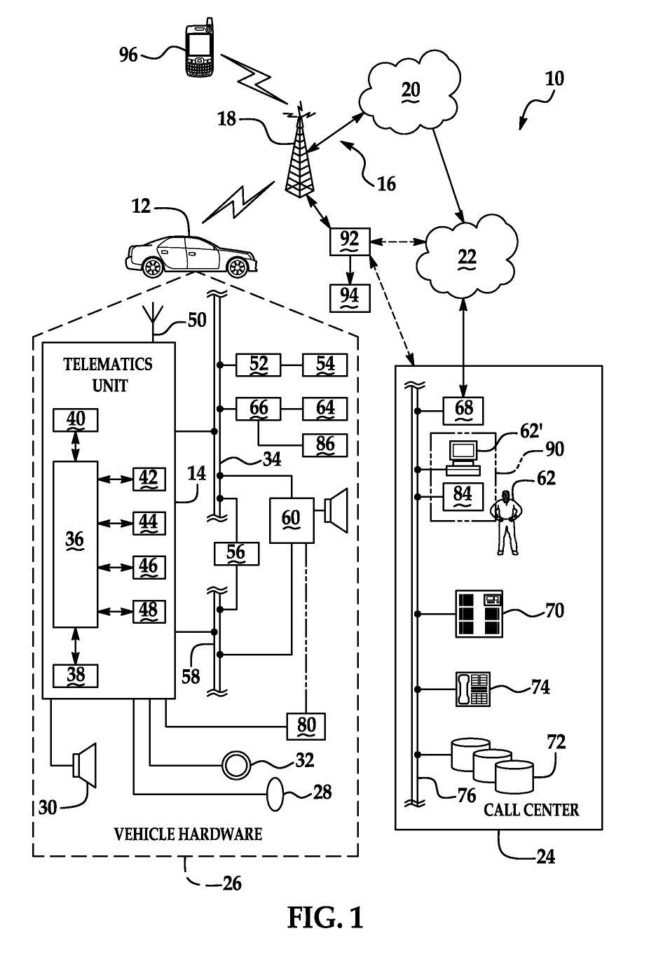

Referring now to FIG. 1, in an example, the system 10 includes the vehicle 12, the telematics unit 14, the wireless carrier/communication system 16 (including, but not limited to, one or more cell towers 18, one or more base stations and/or mobile switching centers (MSCs) 20, and one or more service providers (not shown)), one or more land networks 22, and one or more call centers 24. In an example, the wireless carrier/communication system 16 is a two-way radio frequency communication system.

In another example, the wireless carrier/communication system 16 includes one or more servers 92 operatively connected to a remotely accessible page 94 (e.g., a webpage). In an example, the remotely accessible page 94 is accessible by a vehicle owner, as well as the call center 24. The remotely accessible page 94 is also directly linked to the call center 24, whereby information uploaded to the page 94 may be retrieved, at the time of uploading or shortly thereafter, by the call center 24. The wireless carrier/communication system 16 may, for example, be used to establish communication between the call center 24 and the telematics unit 14.

The wireless carrier/communication system 16 may also be used to establish communication between the call center 24 and an electronic device 96. In many cases, the electronic device 96 is identified in, and is therefore associated with a user profile stored at the call center 24. The electronic device 96 may include any electronic device capable of receiving phone calls, text messages, SMS messages, and/or the like, and/or combinations thereof. Some non-limiting examples of electronic devices 96 include a landline phone, a cellular phone, a personal digital assistant (PDA), a smart phone, a personal computer, a personal laptop computer, a netbook computer, or combinations thereof.

The overall architecture, setup and operation, as well as many of the individual components of the system 10 shown in FIG. 1 are generally known in the art. Thus, the following paragraphs provide a brief overview of one example of such a system 10. It is to be understood, however, that additional components and/or other systems not shown here could employ the method(s) disclosed herein.

Vehicle 12 is a mobile vehicle such as a motorcycle, car, truck, recreational vehicle (RV), boat, plane, etc., and is equipped with suitable hardware and software that enables it to communicate (e.g., transmit and/or receive voice and data communications) over the wireless carrier/communication system 16. It is to be understood that the vehicle 12 may also include additional components suitable for use in the telematics unit 14.

Some of the vehicle hardware 26 is shown generally in FIG. 1, including the telematics unit 14 and other components that are operatively connected to the telematics unit 14. Examples of such other hardware 26 components include a microphone 28, a speaker 30 and buttons, knobs, switches, keyboards, and/or controls 32. Generally, these hardware 26 components enable a user to communicate with the telematics unit 14 and any other system 10 components in communication with the telematics unit 14.

Operatively coupled to the telematics unit 14 is a network connection or vehicle bus 34. Examples of suitable network connections include a controller area network (CAN), a media oriented system transfer (MOST), a local interconnection network (LIN), an Ethernet, and other appropriate connections such as those that conform with known ISO, SAE, and IEEE standards and specifications, to name a few. The vehicle bus 34 enables the vehicle 12 to send and receive signals from the telematics unit 14 to various units of equipment and systems both outside the vehicle 12 and within the vehicle 12 to perform various functions, such as unlocking a door, executing personal comfort settings, and/or the like.

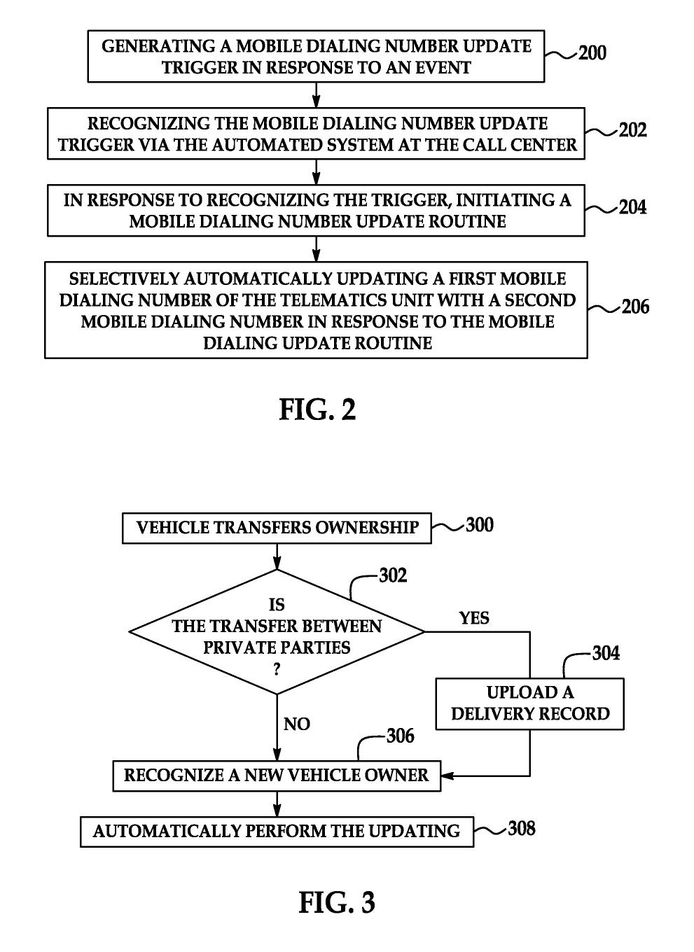

The telematics unit 14 is an onboard device that, when activated, provides a variety of services, both individually and through its communication with the call center 24. To reiterate from above, the telematics unit 14 may be activated when a mobile dialing number is stored therein. In instances where the telematics unit 14 is activated for the first time (or has been reactivated after being previously deactivated), the telematics unit 14 has stored therein a first mobile dialing number. Upon updating the mobile dialing number of the telematics unit 14, the first mobile dialing number may be replaced with a second mobile dialing number. In an example, the second mobile dialing number includes an area code that is local to a then-current garage address of the mobile vehicle 12. In many cases, the area code of the second mobile dialing number is different from the first mobile dialing number. Furthermore, it is to be understood that the terms “first” and “second” used herein in conjunction with the mobile dialing number does not infer that the “first mobile dialing number” and the “second mobile dialing number” are in fact the very first and the very second mobile dialing numbers stored in the telematics unit 14. Rather, the “first” and “second” designations are used instead to infer a sequence of stored mobile dialing numbers; i.e., where the first mobile dialing number precedes the second mobile dialing number regardless of the number of previously stored mobile dialing numbers that the telematics unit 14 may have already had. Details of examples of a method for updating the mobile dialing number of the telematics unit 14 will be described below in conjunction with FIGS. 2-4.

The telematics unit 14 generally includes an electronic processing device 36 operatively coupled to one or more types of electronic memory 38, a cellular chipset/component 40, a wireless modem 42, a navigation unit containing a location detection (e.g., global positioning system (GPS)) chipset/component 44, a real-time clock (RTC) 46, a short-range wireless communication network 48 (e.g., a BLUETOOTH® unit), and/or a dual antenna 50. In one example, the wireless modem 42 includes a computer program and/or set of software routines executing within processing device 36.

It is to be understood that the telematics unit 14 may be implemented without one or more of the above listed components, such as, for example, the wireless modem 42. It is to be further understood that telematics unit 14 may also include additional components and functionality as desired for a particular end use.

The electronic processing device 36 may be a micro controller, a controller, a microprocessor, a host processor, and/or a vehicle communications processor. In another example, electronic processing device 36 may be an application specific integrated circuit (ASIC). Alternatively, electronic processing device 36 may be a processor working in conjunction with a central processing unit (CPU) performing the function of a general-purpose processor.

The location detection chipset/component 44 may include a Global Position System (GPS) receiver, a radio triangulation system, a dead reckoning position system, and/or combinations thereof In particular, a GPS receiver provides accurate time and latitude and longitude coordinates of the vehicle 12 responsive to a GPS broadcast signal received from a GPS satellite constellation (not shown).

The cellular chipset/component 40 may be an analog, digital, dual-mode, dual-band, multi-mode and/or multi-band cellular phone. The cellular chipset-component 40 uses one or more prescribed frequencies in the 800 MHz analog band or in the 800 MHz, 900 MHz, 1900 MHz and higher digital cellular bands. Any suitable protocol may be used, including digital transmission technologies such as TDMA (time division multiple access), CDMA (code division multiple access) and GSM (global system for mobile telecommunications). In some instances, the protocol may be a short-range wireless communication technologies, such as BLUETOOTH®, dedicated short-range communications (DSRC), or Wi-Fi.

Also associated with electronic processing device 36 is the previously mentioned real time clock (RTC) 46, which provides accurate date and time information to the telematics unit 14 hardware and software components that may require and/or request such date and time information. In an example, the RTC 46 may provide date and time information periodically, such as, for example, every ten milliseconds.

The telematics unit 14 provides numerous services, some of which may not be listed herein, and is configured to fulfill one or more user or subscriber requests. Several examples of such services include, but are not limited to: turn-by-turn directions and other navigation-related services provided in conjunction with the GPS based chipset/component 44; airbag deployment notification and other emergency or roadside assistance-related services provided in connection with various crash and or collision sensor interface modules 52 and sensors 54 located throughout the vehicle 12; and infotainment-related services where music, Web pages, movies, television programs, videogames and/or other content is downloaded by an infotainment center 56 operatively connected to the telematics unit 14 via vehicle bus 34 and audio bus 58. In one non-limiting example, downloaded content is stored (e.g., in memory 38) for current or later playback.

Again, the above-listed services are by no means an exhaustive list of all the capabilities of telematics unit 14, but are simply an illustration of some of the services that the telematics unit 14 is capable of offering.

Vehicle communications generally utilize radio transmissions to establish a voice channel with wireless carrier system 16 such that both voice and data transmissions may be sent and received over the voice channel. Vehicle communications are enabled via the cellular chipset/component 40 for voice communications and the wireless modem 42 for data transmission. In order to enable successful data transmission over the voice channel, wireless modem 42 applies some type of encoding or modulation to convert the digital data so that it can communicate through a vocoder or speech codec incorporated in the cellular chipset/component 40. It is to be understood that any suitable encoding or modulation technique that provides an acceptable data rate and bit error may be used with the examples disclosed herein. Generally, dual mode antenna 50 services the location detection chipset/component 44 and the cellular chipset/component 40.

Microphone 28 provides the user with a means for inputting verbal or other auditory commands, and can be equipped with an embedded voice processing unit utilizing human/machine interface (HMI) technology known in the art. Conversely, speaker 30 provides verbal output to the vehicle occupants and can be either a stand-alone speaker specifically dedicated for use with the telematics unit 14 or can be part of a vehicle audio component 60. In either event and as previously mentioned, microphone 28 and speaker 30 enable vehicle hardware 26 and call center 24 to communicate with the occupants through audible speech. The vehicle hardware 26 also includes one or more buttons, knobs, switches, keyboards, and/or controls 32 for enabling a vehicle occupant to activate or engage one or more of the vehicle hardware components. In one example, one of the buttons 32 may be an electronic pushbutton used to initiate voice communication with the call center 24 (whether it be a live advisor 62 or an automated call response system 62′). In another example, one of the buttons 32 may be used to initiate emergency services.

The audio component 60 is operatively connected to the vehicle bus 34 and the audio bus 58. The audio component 60 receives analog information, rendering it as sound, via the audio bus 58. Digital information is received via the vehicle bus 34. The audio component 60 provides AM and FM radio, satellite radio, CD, DVD, multimedia and other like functionality independent of the infotainment center 56. Audio component 60 may contain a speaker system, or may utilize speaker 30 via arbitration on vehicle bus 34 and/or audio bus 58.

The vehicle crash and/or collision detection sensor interface 52 is/are operatively connected to the vehicle bus 34. The crash sensors 54 provide information to the telematics unit 14 via the crash and/or collision detection sensor interface 52 regarding the severity of a vehicle collision, such as the angle of impact and the amount of force sustained.

Other vehicle sensors 64, connected to various sensor interface modules 66 are operatively connected to the vehicle bus 34. Example vehicle sensors 64 include, but are not limited to, gyroscopes, accelerometers, magnetometers, emission detection and/or control sensors, environmental detection sensors, and/or the like. One or more of the sensors 64 enumerated above may be used to obtain the vehicle data for use by the telematics unit 14 or the call center 24 to determine the operation of the vehicle 12. Non-limiting example sensor interface modules 66 include powertrain control, climate control, body control, and/or the like.

In a non-limiting example, the vehicle hardware 26 includes a display 80, which may be operatively directly connected to or in communication with the telematics unit 14, or may be part of the audio component 60. Non-limiting examples of the display 80 include a VFD (Vacuum Fluorescent Display), an LED (Light Emitting Diode) display, a driver information center display, a radio display, an arbitrary text device, a heads-up display (HUD), an LCD (Liquid Crystal Diode) display, and/or the like.

Wireless carrier/communication system 16 may be a cellular telephone system or any other suitable wireless system that transmits signals between the vehicle hardware 26 and land network 22. According to an example, wireless carrier/communication system 16 includes one or more cell towers 18, base stations and/or mobile switching centers (MSCs) 20, as well as any other networking components required to connect the wireless system 16 with land network 22. It is to be understood that various cell tower/base station/MSC arrangements are possible and could be used with wireless system 16. For example, a base station 20 and a cell tower 18 may be co-located at the same site or they could be remotely located, and a single base station 20 may be coupled to various cell towers 18 or various base stations 20 could be coupled with a single MSC 20. A speech codec or vocoder may also be incorporated in one or more of the base stations 20, but depending on the particular architecture of the wireless network 16, it could be incorporated within a Mobile Switching Center 20 or some other network components as well.

Land network 22 may be a conventional land-based telecommunications network that is connected to one or more landline telephones and connects wireless carrier/communication network 16 to call center 24. For example, land network 22 may include a public switched telephone network (PSTN) and/or an Internet protocol (IP) network. It is to be understood that one or more segments of the land network 22 may be implemented in the form of a standard wired network, a fiber of other optical network, a cable network, other wireless networks such as wireless local networks (WLANs) or networks providing broadband wireless access (BWA), or any combination thereof

Call center 24, which is in selective and operative communication with the activated telematics unit 14, is designed to provide the vehicle hardware 26 with a number of different system back-end functions. According to the example shown here, the call center 24 generally includes one or more switches 68, servers 70, databases 72, live and/or automated advisors 62, 62′, a processor 84, as well as a variety of other telecommunication and computer equipment 74 that is known to those skilled in the art. In an example, the call center 24 further includes an automated system 90 that incorporates the automated advisor 62′ and the processor 84. In other instances, the automated system 90 includes its own processor separate from the processor 84 of the call center 24. It is to be understood that when the processor 84 is discussed herein, such description is applicable to both the call center processor 84 and a second processor that may be part of the automated system 90. These various call center components are coupled to one another via a network connection or bus 76, such as one similar to the vehicle bus 34 previously described in connection with the vehicle hardware 26.

The processor 84, which is often used in conjunction with the computer equipment 74, is generally equipped with suitable software and/or programs configured to accomplish a variety of call center 24 functions. Such software and/or programs include computer readable code enabling the computer equipment 74 to perform at least some of the steps of the examples of the updating method disclosed hereinbelow.

The live advisor 62 may be physically present at the call center 24 or may be located remote from the call center 24 while communicating therethrough.

Switch 68, which may be a private branch exchange (PBX) switch, routes incoming signals so that voice transmissions are usually sent to either the live advisor 62 or the automated response system 62′, and data transmissions are passed on to a modem or other piece of equipment (not shown) for demodulation and further signal processing. The modem preferably includes an encoder, as previously explained, and can be connected to various devices such as the server 70 and database 72. For example, database 72 may be designed to store subscriber profile records, subscriber behavioral patterns, or any other pertinent subscriber information. Although the illustrated example has been described as it would be used in conjunction with a manned call center 24, it is to be appreciated that the call center 24 may be any central or remote facility, manned or unmanned, mobile or fixed, to or from which it is desirable to exchange voice and data communications.

A cellular service provider generally owns and/or operates the wireless carrier/communication system 16. It is to be understood that, although the cellular service provider (not shown) may be located at the call center 24, the call center 24 is a separate and distinct entity from the cellular service provider. In an example, the cellular service provider is located remote from the call center 24. A cellular service provider provides the user with telephone and/or Internet services, while the call center 24 is a telematics service provider. The cellular service provider is generally a wireless carrier (such as, for example, Verizon Wireless®, AT&T®, Sprint®, etc.). It is to be understood that the cellular service provider may interact with the call center 24 to provide various service(s) to the user.

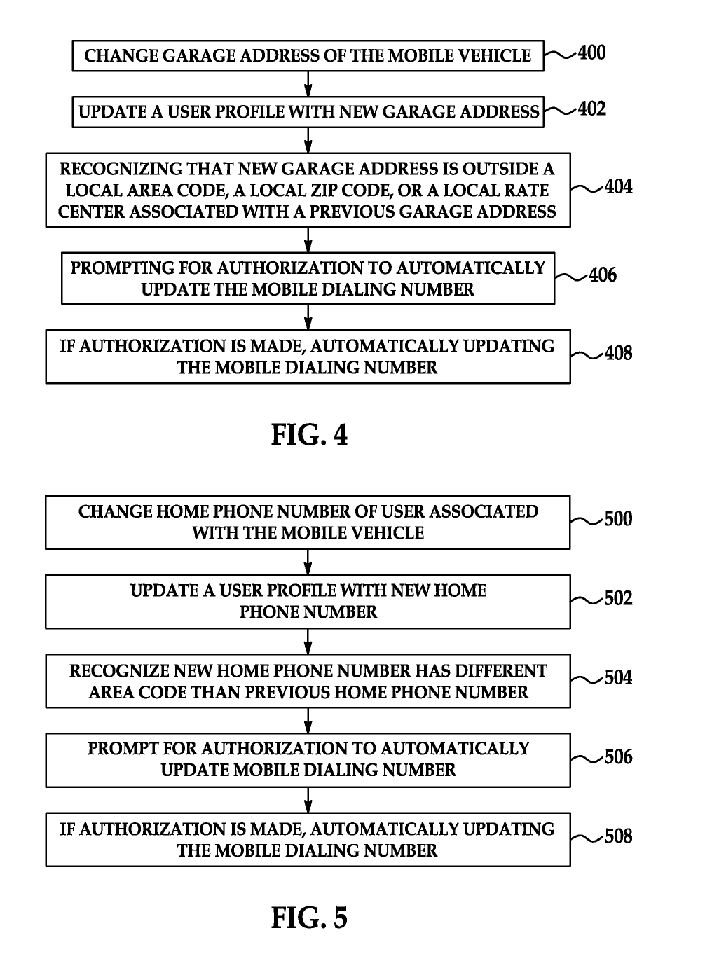

An example of the method for updating the mobile dialing number of the telematics unit 14 is generally depicted in FIG. 2, while more specific examples of such method are depicted in FIGS. 3 and 4. Starting with FIG. 2, in an example, the method for updating the mobile dialing number of the telematics unit 14 includes generating a mobile dialing number update trigger in response to an event (as shown by reference numeral 200). The mobile dialing number update trigger may, for example, be generated by the processor 84 operatively associated with the automated system 90 at the call center 24. More specifically, the processor 84 is configured with suitable computer program code that enables the processor 84 to i) detect the occurrence of an event, and ii) generate the update trigger in response to such detection.

As used herein, the term “event” refers to a predefined happening that, upon detecting the occurrence thereof, causes the processor 84 to generate the mobile dialing number update trigger. Some non-limiting examples of such events include a transfer of ownership of the mobile vehicle 12, a change in the garage address of the mobile vehicle 12, or combinations thereof. Such events will be described in further detail hereinbelow in conjunction with FIG. 3 (where the event includes a transfer of ownership of the mobile vehicle 12) and FIG. 4 (where the event includes a change in the garage address of the mobile vehicle 12).

In an example, the detection of the occurrence of an event may be accomplished as soon as the call center 24 is notified that the event has in fact occurred. For instance, if the event includes a change in the garage address of the vehicle owner, upon notifying the call center 24 that the garage address has changed, the processor 84 has detected the event. Non-limiting examples of notifying the call center 24 include uploading the new garage address into the user profile stored at the call center 24 using the remotely accessible page 94, submitting a voice call into the call center 24, or the like.

The processor 84 thereafter determines whether or not the detected event qualifies as a trigger for initiating a mobile dialing number update. The event will qualify as a trigger when it is determined that the mobile dialing number may no longer be of use to the current vehicle user (i.e., vehicle ownership has changed hands) and/or when the mobile dialing number no longer corresponds with the current vehicle user's garage address. A change in the user's home phone number may also be a trigger that the mobile dialing number may no longer be of use. When determined to be a trigger for updating the mobile dialing number of the telematics unit 14 (as shown by reference numeral 202 in FIG. 2), the processor 84 initiates a mobile dialing number update routine. The update route is operated by the processor 84, and is used to i) ultimately update the mobile dialing number of the telematics unit 14, or ii) simply confirm with the vehicle user that the current mobile dialing number of the telematics unit 14 is suitable.

As such, in response to the recognizing of the trigger, the method further includes initiating the mobile dialing number update routine (as shown by reference numeral 204 in FIG. 2). The mobile dialing number update routine is used to generate a new mobile dialing number for the telematics unit 14. In an example, the new mobile dialing number at least includes the local area code of the garage address of the vehicle owner. In some instances, the new mobile dialing number also includes a requested seven digit number along with the local area code of the vehicle owner's garage address.

When the new mobile dialing number is generated, the method further includes selectively automatically updating, via the automated system 90, the then current (i.e., the first) mobile dialing number of the telematics unit 14 with the second, new mobile dialing number (as shown by reference numeral 206 in FIG. 2). As used herein, the phrase “selectively automatically updating” refers to instances where i) the mobile dialing number is automatically updated as soon as the new dialing number is generated via the mobile dialing number update routine, or ii) the mobile dialing number is automatically updated only after the vehicle owner has authorized such updating. Such instances will be described in further detail below in conjunction with the examples depicted in FIGS. 3 and 4.

Some more specific examples of the method described above in conjunction with FIG. 2 will now be described. In one of these examples, the mobile dialing number update trigger includes a transfer of ownership of the mobile vehicle 12. This example will be discussed herein with reference to FIG. 3. In another one of these examples, the mobile dialing number update trigger includes a change in the garage address of the mobile vehicle 12. The latter example will be disclosed herein with reference to FIG. 4.

Referring now to the example depicted in FIG. 3, the mobile dialing number update trigger may be generated upon detecting, by the processor 84, that the vehicle 12 has actually transferred ownership (as shown by reference numeral 300). The generating of the trigger occurs, for example, when the user profile stored at the call center 24 is updated with new information pertaining to the new vehicle owner (such as, e.g., the new vehicle owner's name, address, phone number, and/or the like). In some instances, the updating of the user profile may automatically occur upon completing the transaction. This generally occurs when the transfer of ownership takes place between a public entity (e.g., a dealership) and a private party (e.g., a customer). In such instances, the dealership updates the user profile and electronically pushes the update to the call center 24. As one example, the profile may be updated as soon as payment for the vehicle is logged into its computer system. In other instances, the call center 24 may poll dealerships for profile changes. In instances where a user profile does not already exist, one may be created by the call center 24 after receiving the information from the dealership upon completion of the transaction. It is to be understood that if a user profile of the new owner does not exist, the dealership may create one and send it to the call center 24. The dealership may amalgamate factory data and customer data on their internal system, and then may send such information to the call center 24 who will save such information in the database 72. In some instances, the call center 24 may have to complete the record with, for example, calling plan information, etc.

In other instances, the updating of the user profile may occur by, e.g., one of the parties (i.e., the buyer or the seller) involved in a private transaction once the transaction is complete (see reference numeral 302 of FIG. 3). For example, the buyer or the seller may access the remotely accessible page 94 and upload a delivery record of the transaction as soon as ownership has changed hands (as shown by reference numeral 304 in FIG. 3). In another instance, the buyer may input transaction information (i.e., the delivery record) using telematics pushbuttons or a keyboard (e.g., controls 32), which is delivered to the call center 24. This delivery record may include, e.g., the VIN number of the vehicle, the date the transaction was completed, the new vehicle owner's name, address, phone number, and/or other information pertaining to the recent transaction. In instances where a user profile for the buyer does not already exist, the buyer may also use the remotely accessible page 92 to generate a new user profile and then the delivery record may be uploaded to the newly created profile. In other instances where a user profile for the buyer does not already exist, the buyer may call the cell center 24 and request that a user profile be created for him/her.

Regardless of the type of transaction that has occurred (e.g., a public transaction or a private transaction), the updated user profile may be recognized, by the processor 84 associated with the automated system 90, as a trigger for updating the mobile dialing number of the telematics unit 14. In other words, the processor 84 will recognize that the user profile has been updated, which indicates that i) the former vehicle owner is no longer associated with the vehicle 12 (thus indicating that there is a new owner), or ii) a new vehicle owner is associated with the vehicle 12 (as shown by reference numeral 306 in FIG. 3). In response to the recognizing of the new vehicle owner, the mobile dialing number of the telematics unit 14 may then be selectively automatically updated. Such selective automatic updating may be accomplished by automatically replacing, via the automated system 90, the first (i.e., the existing) mobile dialing number with a second (i.e., new) mobile dialing number (as shown by reference numeral 308 in FIG. 3).

In an example, the second mobile dialing number (i.e., the mobile dialing number replacing the existing mobile dialing number) includes at least the area code that is local to a then-current garage address of the mobile vehicle 12. For instance, if the garage address of the new vehicle owner is in Mt. Clemens, MI, then the mobile dialing number of the telematics unit 14 may be updated with a new mobile dialing number that has an area code corresponding with the area code local to Mt. Clemens (e.g., 586). The remaining seven digits of the new (i.e., the second) mobile dialing number may be selected by the new vehicle owner assuming that the selected number is available. Otherwise, a new seven digit dialing number having the new local area code will be selected for the new vehicle owner by the call center 24 based on which numbers are currently available.

Once the mobile dialing number has been updated in the vehicle 12, the call center 24 may contact the new vehicle owner in order to establish a relationship with the new owner, and potentially to sell a telematics service provider package (including calling minutes, etc.) to the new vehicle owner (if this person has not previously subscribed to such services).

Referring now to the example of the method depicted in FIG. 4, the mobile dialing update trigger includes a change in the garage address of the mobile vehicle 12. In this example, the current vehicle owner changes his/her garage address (as shown by reference numeral 400 in FIG. 4) and then updates the user profile at the call center 24 with the new garage address (as shown by reference numeral 402 in FIG. 4). In an example, the updating of the user profile may be accomplished again by accessing the remotely accessible page 92 and uploading the vehicle owner's new garage address thereon.

Once the new garage address has been uploaded, the automated system 90 at the call center 24 recognizes the change. In response to the recognized trigger, the processor 84 runs a comparison algorithm (or other suitable computer readable code) to determine if the new garage address is associated with a different local calling area than the previous garage address. More particularly, the comparison algorithm compares the new garage address with the old garage address to determine if one or more of the area code, zip code, and local rate center (i.e., the geographic area used by local exchange carriers to set rate boundaries for filling and/or for issuing phone numbers) has changed as a result of the change in address. In response to the comparison algorithm, the automated system 90 may recognize that the new garage address is outside of the local area code, the local zip code, and/or the local rate center associated with the previous garage address (as shown by reference numeral 404 in FIG. 4). For instance, if the new garage address has a zip code of 48084, then the local area code of the dialing number would be 248. Upon comparing the new garage address with the old garage address (which may have a zip code of, e.g., 48230), the processor 84 will recognize that the zip code of 48230 does not correspond with the same local area code as the zip code of 48084. In this instance, a new mobile dialing number is generated having a local area code of 248.

In an example, upon recognizing that the new garage address is outside of the local area code, the local zip code, and/or the local rate center, the automated system 90 may automatically update the mobile dialing number of the telematics unit 14. Since area codes and local rate centers may span more than one zip code, the automatic update feature of the system 10 may be particularly desirable when an area code and/or local rate center change is identified. However, the automatic update of the mobile dialing number upon recognizing any of the changes may be set as the default mode.

It is to be understood, however, that in some instances, an automatic update (which would be initiated by the automated system 90 without authorization by the vehicle owner) may be undesirable by the vehicle owner. It is to be understood that one of the options for the user's profile may be to always prompt the user for number change authorization. By selecting this option for his/her profile, the user may override the automatic update mode. For example, the vehicle owner may want to keep his/her old mobile dialing number for convenience purposes even though he/she may incur additional long distance charges, etc. By selecting the always prompt mode for his/her profile, the vehicle owner will be prompted, by the automated system 90, for authorization to automatically update the mobile dialing number of the telematics unit 14.

It is to be understood that the vehicle owner may be prompted for authorization in real time in response to the automated system 90 recognizing that the new garage address is outside of the local area code, the local zip code, and/or the local rate center associated with the previous garage address. Such prompting may be accomplished by sending, via a wireless or a wired connection from the call center 24 to the electronic device 96, an e-mail, an SMS, a text message, a voice call, or combinations thereof When the vehicle owner receives the prompt, he/she will either authorize the update or decline it. In instances where the update is authorized, the automated system 90 proceeds to automatically update the first mobile dialing number of the telematics unit 14 with the second, new mobile dialing number (see reference numeral 408 of FIG. 4). However, in instances where authorization is declined, the automated system 90 is configured to override the automatic update so that the first mobile dialing number remains in the telematics unit 14.

Referring now to the example of the method depicted in FIG. 5, the mobile dialing update trigger includes a change in the home phone number associated with the mobile vehicle 12. In this example, the current vehicle owner changes his/her home phone number (as shown by reference numeral 500 in FIG. 5) and then updates the user profile at the call center 24 with the new home phone number (as shown by reference numeral 502 in FIG. 5). In an example, the updating of the user profile may be accomplished again by accessing the remotely accessible page 92 and uploading the vehicle owner's new home phone number thereon.

Once the new home phone number has been uploaded, the automated system 90 at the call center 24 recognizes the change. In response to the recognized trigger, the processor 84 runs a comparison algorithm (or other suitable computer readable code) to determine if the new home phone number is associated with a different local calling area than the previous home phone number. More particularly, the comparison algorithm compares the new home phone number with the old home phone number to determine if the area code has changed. If the home phone area code has changed, there is a high probability that the area code of the mobile dialing number in the vehicle has also changed.

In an example, upon recognizing that the new home phone number has a different local area code, the automated system 90 may automatically update the mobile dialing number of the telematics unit 14. In some instances, the automatic update of the mobile dialing number upon recognizing any of the area code change may be set as the default mode.

As previously discussed in reference to FIG. 4, the automatic update (which would be initiated by the automated system 90 without authorization by the vehicle owner) may be undesirable by the vehicle owner. Again, one of the options for the user's profile may be to always prompt the user for number change authorization. By selecting this option for his/her profile, the user may override the automatic update mode. For example, the vehicle owner may want to keep his/her old mobile dialing number for convenience purposes even though he/she may incur additional long distance charges, etc. By selecting the always prompt mode for his/her profile, the vehicle owner will be prompted, by the automated system 90, for authorization to automatically update the mobile dialing number of the telematics unit 14.

It is to be understood that the vehicle owner may be prompted for authorization in real time in response to the automated system 90 recognizing that the area code of the home phone number has changed. Such prompting may be accomplished as described hereinabove. When the vehicle owner receives the prompt, he/she will either authorize the update or decline it. In instances where the update is authorized, the automated system 90 proceeds to automatically update the first mobile dialing number of the telematics unit 14 with the second, new mobile dialing number (as shown at reference numeral 508 of FIG. 5). However, in instances where authorization is declined, the automated system 90 is configured to override the automatic update so that the first mobile dialing number remains in the telematics unit 14.

While several examples have been described in detail, it will be apparent to those skilled in the art that the disclosed examples may be modified. Therefore, the foregoing description is to be considered exemplary rather than limiting.

1. A method of updating a mobile dialing number of a telematics-equipped mobile vehicle, the method comprising:
generating, via a processor operatively associated with an automated system at a call center, a mobile dialing number update trigger in response to an event, the call center being in selective and operative communication with an activated telematics unit having a first mobile dialing number;
recognizing the mobile dialing number update trigger via the automated system;
in response to the recognizing, via the automated system, initiating a mobile dialing number update routine; and
selectively automatically updating, via the automated system, the first mobile dialing number with a second mobile dialing number in response to the mobile dialing number update routine.

2. The method as defined in claim 1 wherein the event includes a transfer of ownership of the mobile vehicle, wherein the mobile dialing number update routine includes recognizing a new vehicle owner, and wherein selectively automatically updating includes automatically performing the updating in response to the recognition of the new user so that the first mobile dialing number is replaced with the second mobile dialing number.

3. The method as defined in claim 2 wherein the transfer of ownership of the mobile vehicle occurs between private parties, and wherein prior to the recognizing of the mobile dialing number update trigger, the method further comprises uploading a delivery record of the mobile vehicle to the call center.

4. The method as defined in claim 1 wherein the event includes a change in the garage address of the mobile vehicle, and wherein prior to recognizing the mobile dialing update trigger, the method further comprises updating a user profile with a new garage address, the updating being accomplished by accessing a remotely accessible page in selective and operative communication with the call center.

5. The method as defined in claim 4 wherein the recognizing of the mobile dialing update trigger includes recognizing that the new garage address is outside of a local area code, a local zip code, or a local rate center associated with a previous garage address.

6. The method as defined in claim 5 wherein the recognizing that the new garage address is outside of the local area code, the local zip code, or the local rate center includes:
comparing the previous garage address with the new garage address; and
determining that an area code associated with the new garage address is different from the local area code, the local zip code, or the local rate center associated with the previous garage address.

7. The method as defined in claim 5 wherein upon recognizing that the new garage address is outside of the local area code, the local zip code, or the local rate center associated with the previous garage address, the method further comprises prompting for authorization to automatically update the mobile dialing number of the vehicle.

8. The method as defined in claim 7 wherein the prompting is accomplished in real time in response to the recognizing that the new garage address is outside of the local area code, the local zip code, or the local rate center associated with the previous garage address.

9. The method as defined in claim 7 wherein the prompting is accomplished by sending, to an electronic device associated with the user profile, an e-mail, an SMS, a text message, a voice call, or combinations thereof.

10. The method as defined in claim 7 wherein when the authorization is made, the method further includes automatically updating the first mobile dialing number with the second mobile dialing number.

11. The method as defined in claim 7 wherein when the authorization is declined, prior to selectively automatically updating the mobile dialing number, the method further comprises overriding the selective automatic update so that the first mobile dialing number remains in the telematics unit.

12. The method as defined in claim 1 wherein the second mobile dialing number includes an area code local to a then-current garage address of the mobile vehicle.

13. The method as defined in claim 1 wherein the event includes a change in a home phone number associated with the mobile vehicle, and wherein prior to recognizing the mobile dialing update trigger, the method further comprises updating a user profile with a new home phone number, the updating being accomplished by accessing a remotely accessible page in selective and operative communication with the call center.

14. A system for updating a mobile dialing number of a telematics-equipped mobile vehicle, comprising:
an activated telematics unit operatively disposed in the mobile vehicle, the activated telematics unit having a first mobile dialing number;
means for generating a mobile dialing update trigger in response to an event; and
a call center in selective and operative communication with the activated telematics unit, the call center including an automated system having a processor including computer readable medium encoded with:
computer readable code for recognizing the mobile dialing number update trigger;
computer readable code for initiating, in response to the recognizing, a mobile dialing update routine; and
computer readable code for selectively automatically updating the first mobile dialing number with a second mobile dialing number in response to the mobile dialing number update routine.

15. The system as defined in claim 14 wherein: the event includes a transfer of ownership of the mobile vehicle; the mobile dialing update routine includes computer readable code for recognizing a new vehicle owner; and the computer readable code for selectively automatically updating the first mobile dialing number includes computer readable code for performing the updating in response to the recognition of the new vehicle owner so that the first mobile dialing number is replaced with the second mobile dialing number.

16. The system as defined in claim 15 wherein the transfer of ownership occurs between private parties, and wherein the system further comprises a remotely accessible page configured to have uploaded thereto a delivery record of the mobile vehicle to the call center.

17. The system as defined in claim 14 wherein the event includes a change in the garage address of the mobile vehicle or a home phone number associated with the mobile vehicle, and wherein the system further comprises a remotely accessible page in selective and operative communication with the call center, the remotely accessible page configured to be used for updating a user profile with a new garage address or a new home phone number.

18. The system as defined in claim 17 wherein the computer readable code for recognizing the mobile dialing number update trigger includes computer readable code for recognizing that the new garage address is outside of a local area code, a local zip code, or a local rate center associated with a previous garage address.

19. The system as defined in claim 17, further comprising an electronic device associated with the user profile and configured to receive a prompt from the automated system for authorization to automatically update the mobile dialing number of the mobile vehicle.

20. The system as defined in claim 14 wherein the second mobile dialing number includes an area code local to a then-current garage address of the mobile vehicle.
